(19) United States
(12) Patent Application Publication
(10) Pub. No.: US 2005/0266922 A1
(43) Pub. Date: Dec. 1, 2005

(54) Computer game controller mounting seat

(76) Inventor: Geoffrey Malcolm Lee, San Jose, CA (US)

Correspondence Address: Geoffrey Malcolm Lee, 5391 Country Club Parkway, San Jose, CA, 95138, US

(21) Appl. No.: 11/098,136

(22) Filed: Apr. 4, 2005

Related U.S. Application Data
(60) Provisional application No. 60/574,976, filed on May 28, 2004.

(51) Int. Cl. A63F 9/24; A63F 13/00; G06F 17/00; G06F 19/00

(52) U.S. Cl. 463/37

(57) ABSTRACT

The invention is a computer game controller mounting seat incorporated into a chair seat overlay.

The device is designed to attach to any suitable chair, (also to include some wheel chairs), by using a simple strap and the natural body weight of the user. Ref. FIGS. 1 & 5 Raised platforms on each side of the overlay physically locate game controllers in a comfortable and ergonomically correct location. Lower levels of these platforms are convenient for storage and computer “mouse” utilization on left or right sides.

A separate, removable central platform or console will accommodate single stick controllers, keyboards, laptop computers, etc. ref. FIGS. 4, 5 and 6.

Be it known that I, Geoffrey M. Lee, a citizen of the United States, have invented a new and useful Computer game controller mounting seat to mount game control devices: a device of which the following is a specification. This application claims the benefit of provisional application No. 60/574,976, filing date May 28, 2004

The purpose of this invention is to provide easily portable/stowable mounting platforms, not incorporated into a dedicated chair, that support computer game control devices, keyboards, laptops etc. in a comfortable and ergonomically correct location for the player and obviate the need for additional desk/table-top space.

### BACKGROUND OF THE INVENTION

1. Field of the Invention

This invention relates generally to the field of apparatus for a Computer seat mounting game control devices. Moreover, it pertains specifically to such apparatus for the comfortable and ergonomically correct seating position for the operator of computer gaming control and keyboard devices.

2. Description of Prior Art

In recent times the popularity of computer simulation/games has exploded, particularly simulations related to the use of joystick and throttle. There are several “chairs” currently available on the market all of which are comprised of a totally dedicated chair with various audio, mechanical motion and controller mounting facilities attached. (eg. Battle chair.com). It is not evident that any of the existing examples are totally portable or easily stowable. None of their controller mounting facilities can be applied to any chair other than that into which they are incorporated. There do not seem to exist any examples that incorporate any facility to mount lap top computers, key boards or computer mouse.

None may be applied to any wheel chair product.

The complexity of the existing chairs engenders high cost of ownership and very limited market.

### SUMMARY OF THE INVENTION

The purpose of the present invention is to provide a new computer game controller mounting device that has many novel features not offered by the prior art apparatus that result in a new computer game controller mounting seat which is not apparent, obvious, or suggested, either directly or indirectly by any of the prior art apparatus.

The invention takes the form of a “seat overlay” and may be placed on the seat of any suitable chair and secured with a strap or bungee cord. The body weight of the user provides additional security. Game control devices, i.e., joystick and throttle) are mounted on platforms located on each side of the overlay. Single stick controllers (requiring the use of both hands in close proximity), keyboards or laptops can be mounted on a removable central console. Ref. FIG. 4, 5 and 6

### DESCRIPTION

The present invention is comprised of a seat shaped pan or base having, as an adjunct, on each side, an additional “wing” supporting two platforms. Ref. FIG. 1, 6

Each of these platforms is located such that any operator does not have to extend his arms unduly to grasp the control device in use. Each platform is elevated to a height that comfortably raises game controllers to a position such that the operator's arms, from shoulder to elbow, are located vertically and, from elbow to hand, the forearm is essentially parallel to the ground. The central seat shape may be flat or “dished.” For comfort a central aperture is provided to accommodate human bone structures. Ref. FIG. 2, 6

Two slots on each side of the seat accommodate a mounting strap to secure the seat to an appropriate chair. On the front edge of the pan there are incorporated several straps or clamps to secure cabling associated with game controllers. Ref. FIG. 1, 6. Conductors molded into the seat pan will serve wiring interconnections more efficiently

Velcro pads adhered to the top surface of each platform may be utilized to secure controllers. On the inside face of each platform there is a rail that supports a removable central console. This accessory is a simple elongated “u” shaped piece that is mounted on the inside rails and held in place by two dowel pins and the spring tension inherent in the material of the piece. Ref. FIGS. 1, 4 and 5

The foregoing has outlined, in general, the physical aspects of the invention and is to serve as an aid to better understanding the more complete detailed description that is to follow. In reference to such, there is to be a clear understanding that the present invention is not limited to the method or detail of construction, fabrication, material, or application of use described and illustrated herein. Any other variation of fabrication, ie. injection molding, vacuum forming, use or application should be considered apparent as an alternative embodiment of the present invention.

### OBJECTS OF THE INVENTION

Accordingly, several advantages and objects of the present invention are:

A principal object of the present invention is to provide a mounting platform for computer simulation and gaming controllers that will overcome the expense, lack of portability and other deficiencies of the prior arts.

An object of the present invention is to provide a device that supplies utility and ergonomic benefits to all users of computer and simulation game controllers

Another object of the present invention is to provide a device that minimizes the need for desk or table in order to use controllers, keyboards, laptop computers, etc.

Another object of the present invention is to provide a device that is simple to install on any suitable chair. and readily dismantle.

Another object of the present invention is to provide a device that could provide benefits to disabled people in the form of access to gaming devices and convenient usage of laptops, etc.

Another object of the present invention is to provide a more cost effective device that is more universally functional in today's market than the prior art devices.

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention.

Each drawing is referenced by corresponding figure reference characters within the “DETAILED DESCRIPTION OF THE INVENTION” section to follow;

FIG. 1. is a perspective view of a computer game controller seat assembly according to the present invention.

FIG. 2. is a dimensional plan and side view of the base or pan of the computer game controller seat according to the present invention.

FIG. 3. is a dimensional and perspective, rear and side view of the support platforms incorporated into the computer game controller seat according to the present invention.

FIG. 4. is a dimensional depiction of the removable central console according to the present invention.

FIG. 5. is a view of the invention being utilized with a typical stick & throttle mounted on the platforms, and reflecting the convenient mouse position.

FIG. 6. Depicts the invention in use, showing mouse position and facility of use and exit attendant upon the console.

### DETAILED DESCRIPTION OF THE INVENTION

Referring now descriptively to the drawings, the attached figures illustrate a computer seat overlay.

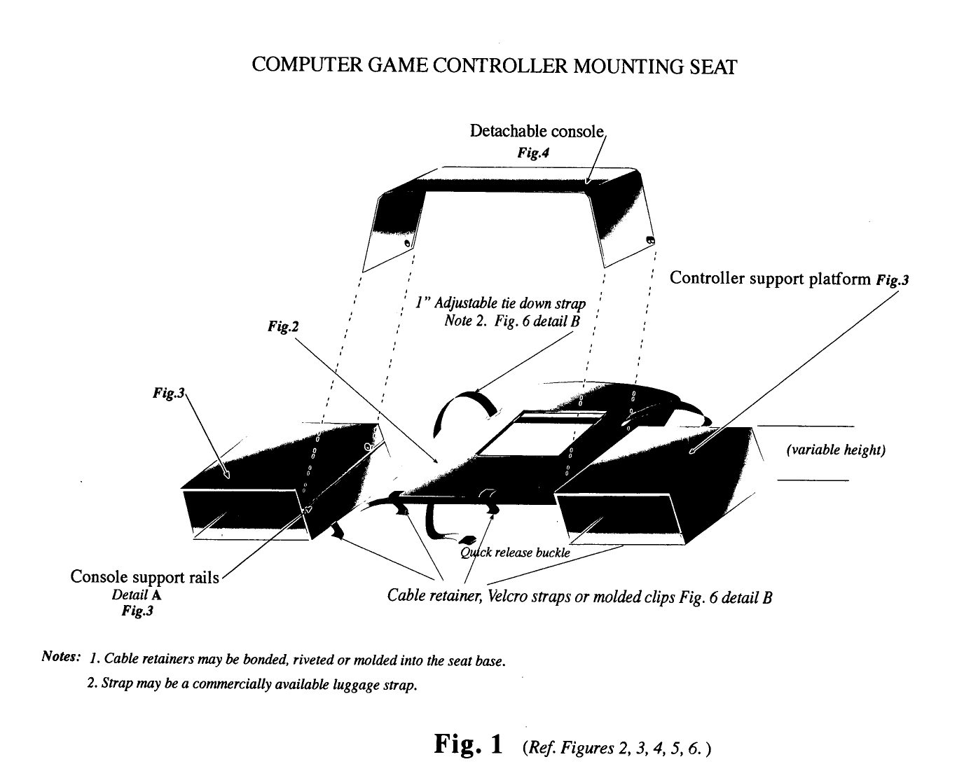

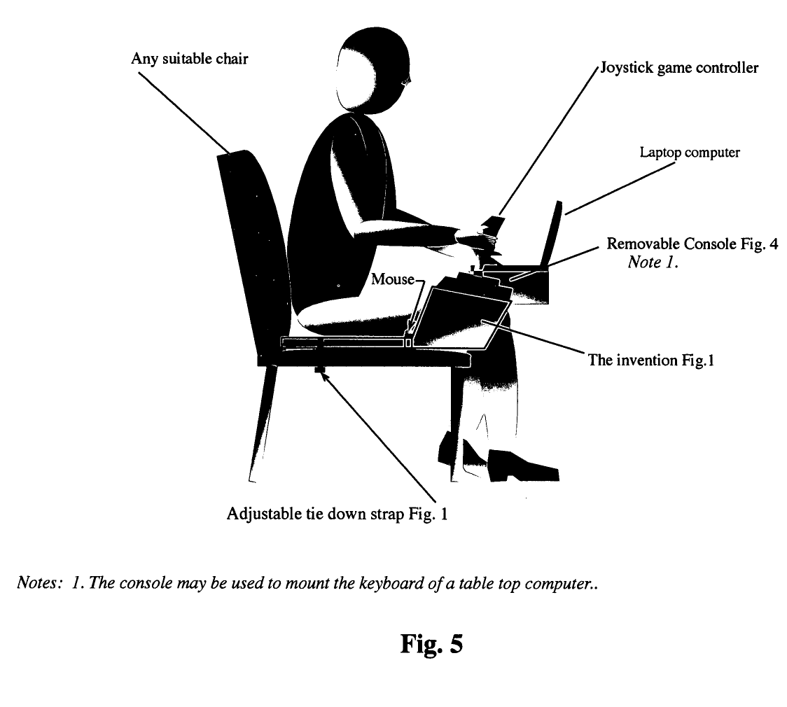

FIGS. 1 through 5 illustrate a computer seat overlay and removable console according to the present invention.

### DESCRIPTION

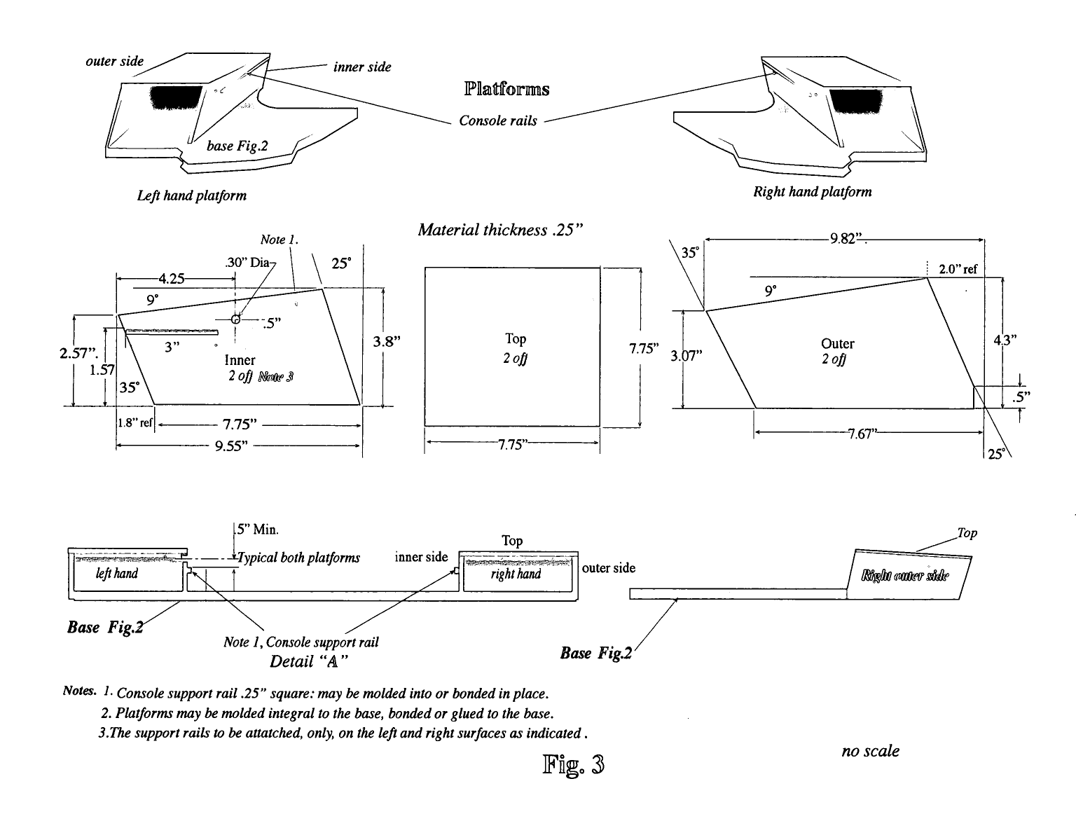

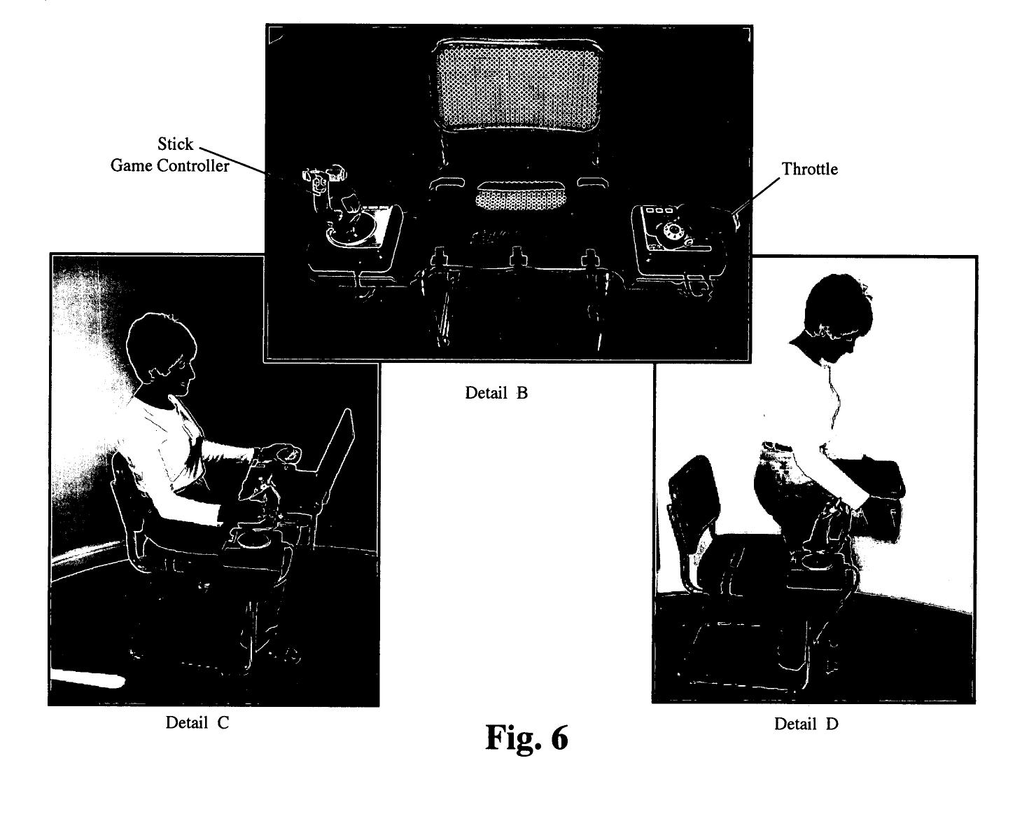

FIG. 1. Shows the present invention is comprised of a seat shaped pan having, as an adjunct, on each side, an additional “wing” supporting two platforms. (FIGS. 3 and 6)

Each of these platforms is located such that any operator does not have to extend his arms unduly to grasp the control device in use. Each platform is elevated to a height that comfortably raises game controllers to a location such that the operator's arms, from shoulder to elbow, are located vertically and, from elbow to hand, the forearm is essentially parallel to the ground.

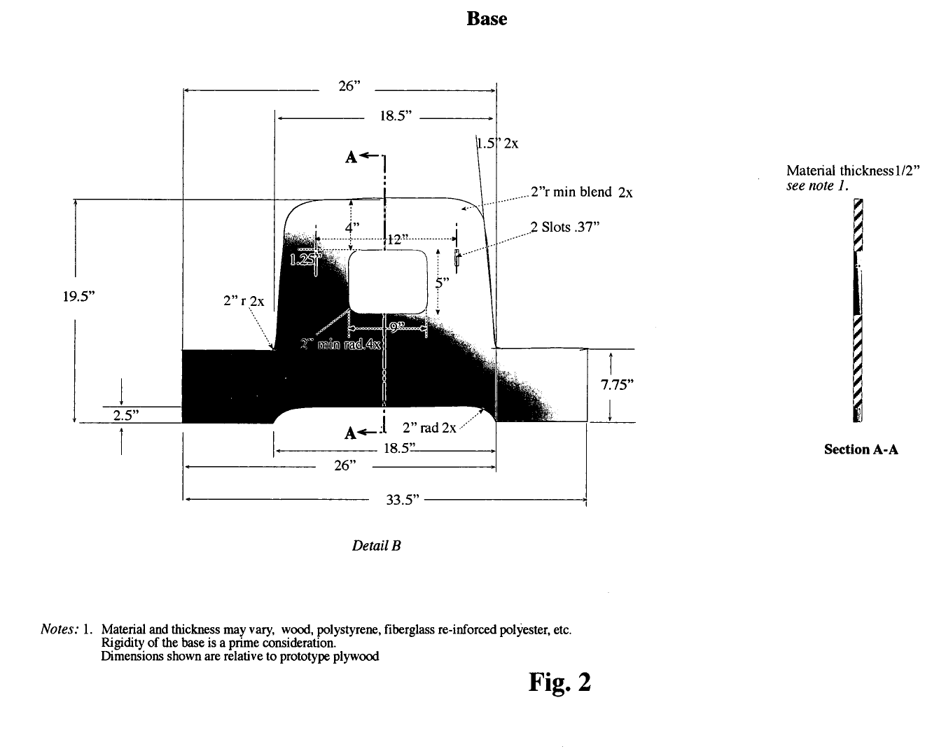

The central seat shape (FIG. 2) may be flat or “dished.” For comfort a central aperture is provided to accommodate human bone structures.

Two slots (, FIG. 1, 2, 5 &6) on each side of the seat accommodate a mounting strap to secure the seat to an appropriate chair.

On the front edge of the pan there are incorporated several straps or clamps to secure cabling interconnecting elements associated with game controllers, (FIG. 1). Conductors molded into the seat pan would obviate the need for these clamps.

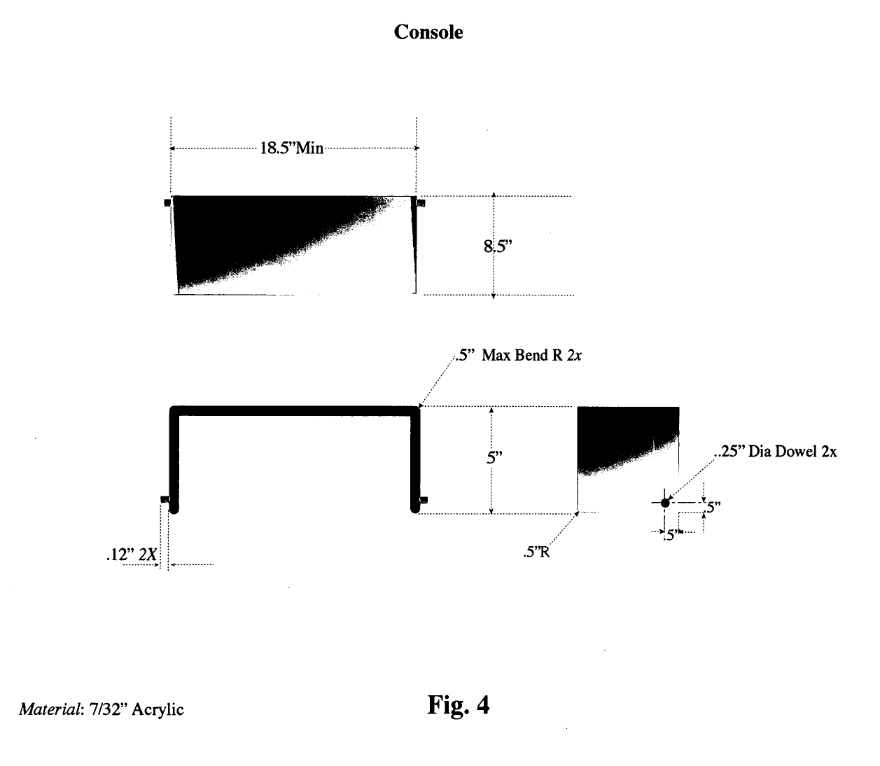

On the inside face of each platform there is a rail (Detail A, FIGS. 1 & 3) that supports the removable central console. A hole on the inside face of each platform accepts the dowels evident on the console (FIG. 4)

This accessory (FIG. 4) is a simple elongated “u” shaped piece that is mounted on the inside rails and held in place by the spring tension fabricated into the legs of the piece. This tension allows easy removal of the console by the action of an inward “squeeze” applied to the legs of the console, thus disengaging the dowels. (FIG. 6, detail C and D)

It will also be understood that, in addition to use as a computer game controller mount, it can provide useful service accommodating keyboard and laptop computers, etc., in comfortable proximity to the user. (FIG. 6, detail C)

The seat overlay may also be adaptable to certain wheel chair applications, aiding the disabled.

It is further intended that any other embodiments of the present invention that result from changes in application or method of use or operation, method of manufacture, shape, size or material which are not specified within the detailed written description or illustrations contained herein, yet are considered apparent or obvious to one skilled in the art, are within the scope of the present invention.

1. The completely portable nature and configuration of the device.

2. The arrangement and combination of the universal seat overlay, controller mounting platforms and removable console.

3. The chair mountable capability and shape of the seat overlay that allows the users body weight in conjunction with the securing strap to locate and secure the overlay in place on any suitable chair and subsequently be readily removable.

4. The adjustable elevation and downward angled controller mounting surfaces incorporated into the controller mounting platforms allowing an ergonomically optimized arm and wrist position for the user.

5. The two layer configuration of the controller mounting platforms, allowing either lower surface to be utilized as a “mouse pad” or game CD storage etc.

6. The incorporated and easily removable console allowing the mounting of laptop computer, keyboard etc. thus obviating the complete reliance on desktop or table space.
The device provides a complete and comprehensive game arrangement for some wheel chair users.
